(19) United States
(12) Patent Application Publication
(10) Pub. No.: US 2023/0232494 A1
(43) Pub. Date: Jul. 20, 2023

(54) METHODS OF COMMUNICATION, TERMINAL DEVICES, NETWORK DEVICES AND COMPUTER READABLE MEDIA

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/007,136

(22) PCT Filed: Jul. 28, 2020
(86) PCT No.: PCT/CN2020/105315

§ 371 Date: Jan. 27, 2023

(51) Int. Cl. H04W 76/34; H04W 76/15

(52) U.S. Cl. CPC H04W 76/34; H04W 76/15

(57) ABSTRACT

Embodiments of the present disclosure relate to methods, devices, and medium for communication. A method of communication comprises in accordance with a determination that a condition for performing a configuration for a primary secondary cell (PScell) of a secondary cell group (SCG) of a second network device is met, determining, at a terminal device served by a first network device, whether the SCG of the second network device is deactivated. The method further comprises in accordance with a determination that the SCG is deactivated, transmitting a third message to the second network device of the SCG, the third message indicating that the configuration for the PScell has been completed by the terminal device.

### TECHNICAL FIELD

Embodiments of the present disclosure generally relate to the field of telecommunication, and in particular, to methods of communication, network devices, terminal devices and computer readable media.

### BACKGROUND

Dual Connectivity (DC) is a mode of operation where a terminal device (for example, user equipment, UE) can be configured to utilize radio resources provided by two network devices, for example, two base stations (BSs). A first network device serves the terminal device as a Master Node (MN), and a second network device serves the terminal device as a Secondary Node (SN). In the traditional DC scenario, the MN and SN may be associated with one or more serving cells usually, and further a carrier aggregation (CA) technology could be implemented for efficient frequency usage. The group of serving cells associated with the MN is referred to as a Master Cell Group (MCG) and the group of serving cells associated with the SN is referred to as a Secondary Cell Group (SCG).

In a DC scenario, the terminal device needs to maintain the radio links with both MN and SN simultaneously, which causes significant power consumption. For example, the power consumption of a DC terminal device is multiple of that of a traditional terminal device (such as, 3 to 4 times of a Long Term Evolution, LTE, terminal device). Further, it is proposed that in some cases (such as, the data rate of the terminal device changes from high to low, and so on), the SCG serving the terminal device may be suspended/deactivated or may be configured in dormancy state to reduce power consumption. However, in case that the SCG is suspended/deactivated, processes for some DC procedures, in particular the procedures relating to configuration SCG, have not been stipulated.

### SUMMARY

In general, example embodiments of the present disclosure provide a solution for configuring SCG in case that the SCG is suspended/deactivated SCG.

In a first aspect, there is provided a method of communication. The method comprises transmitting, at a first network device and to a second network device, a request for configuring a SCG associated with the second network device. The request comprises first information about a first activity state for the SCG. The method further comprises receiving a response to the request from the second network device. The response indicates a current activity state of the SCG. The current activity state is determined based on the first information by the second network device.

In a second aspect, there is provided a method of communication. The method comprises receiving, at a second network device and from a first network device, a request for configuring a SCG associated with the second network device. The request comprises first information about a first activity state for the SCG. The method further comprises determining a current activity state for the SCG based on the first information. The method also comprises transmitting a response to the request to the first network device. The response indicates the current activity state for the SCG.

In a third aspect, there is provided a method of communication. The method comprises receiving, at a first network device and from a second network device, a first message for configuring a SCG associated with the second network device. The first message comprises a requirement about a second activity state of the SCG. The method further comprises transmitting, a second message to the second network device to confirm the first message.

In a fourth aspect, there is provided a method of communication. The method comprises generating, at a second network device, a first message for configuring a SCG associated with the second network device. The first message comprises a parameter about a second activity state of the SCG. The method further comprises transmitting the first message to the first network device.

In a fifth aspect, there is provided a method of communication. The method comprises in accordance with a determination that a condition for performing a configuration for a primary secondary cell (PScell) of a SCG of a second network device is met, determining, at a terminal device served by a first network device, whether the SCG of the second network device is deactivated. The method further comprises in accordance with a determination that the SCG is deactivated, transmitting a third message to the second network device of the SCG. The third message indicates that the configuration for the PScell has been completed by the terminal device.

In a sixth aspect, there is provided a method of communication. The method comprises receiving, at a terminal device and from a second network device, a fourth message for configuring a SCG of the second network. The fourth message comprises a second indication indicating the SCG is deactivated. The method further comprises transmitting a fifth message to the second network device of the SCG. The fifth message indicates that the configuration for the PScell has been completed by the terminal device.

In a seventh aspect, there is provided a network device. The network device includes a processing unit; and a memory coupled to the processing unit and storing instructions thereon, the instructions, when executed by the processing unit, causing the device to perform the method according to the first aspect.

In an eighth aspect, there is provided a network device. The network device includes a processing unit; and a memory coupled to the processing unit and storing instructions thereon, the instructions, when executed by the processing unit, causing the device to perform the method according to the second aspect.

In a ninth aspect, there is provided a network device. The network device includes a processing unit; and a memory coupled to the processing unit and storing instructions thereon, the instructions, when executed by the processing unit, causing the device to perform the method according to the third aspect.

In a tenth aspect, there is provided a network device. The network device includes a processing unit; and a memory coupled to the processing unit and storing instructions thereon, the instructions, when executed by the processing unit, causing the device to perform the method according to the fourth aspect.

In an eleventh aspect, there is provided a terminal device. The terminal device includes a processing unit; and a memory coupled to the processing unit and storing instructions thereon, the instructions, when executed by the processing unit, causing the device to perform the method according to the fifth aspect.

In a twelfth aspect, there is provided a terminal device. The terminal device includes a processing unit; and a memory coupled to the processing unit and storing instructions thereon, the instructions, when executed by the processing unit, causing the device to perform the method according to the sixth aspect.

In a thirteenth aspect, there is provided a computer readable medium having instructions stored thereon, the instructions, when executed on at least one processor, causing the at least one processor to carry out the method according to the first aspect.

In a fourteenth aspect, there is provided a computer readable medium having instructions stored thereon, the instructions, when executed on at least one processor, causing the at least one processor to carry out the method according to the second aspect.

In a fifteenth aspect, there is provided a computer readable medium having instructions stored thereon, the instructions, when executed on at least one processor, causing the at least one processor to carry out the method according to the third aspect.

In a sixteenth aspect, there is provided a computer readable medium having instructions stored thereon, the instructions, when executed on at least one processor, causing the at least one processor to carry out the method according to the fourth aspect.

In a seventeenth aspect, there is provided a computer readable medium having instructions stored thereon, the instructions, when executed on at least one processor, causing the at least one processor to carry out the method according to the fifth aspect.

In an eighteenth aspect, there is provided a computer readable medium having instructions stored thereon, the instructions, when executed on at least one processor, causing the at least one processor to carry out the method according to the sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a block diagram of a communication environment in which embodiments of the present disclosure can be implemented;

FIGS. 2A-2D are signaling charts illustrating processes of exchanging activity state information according to some embodiments of the present disclosure, respectively;

FIGS. 3A and 3B are signaling charts illustrating processes for configuring SCG according to some embodiments of the present disclosure, respectively;

FIG. 4 illustrates an example method of communication implemented at a first network device in accordance with some embodiments of the present disclosure;

FIG. 5 illustrates an example method of communication implemented at a second network device in accordance with some embodiments of the present disclosure;

FIG. 6 illustrates another example method of communication implemented at a first network device in accordance with some embodiments of the present disclosure;

FIG. 7 illustrates another example method of communication implemented at a second network device in accordance with some embodiments of the present disclosure;

FIG. 8 illustrates an example method of communication implemented at a terminal device in accordance with some embodiments of the present disclosure;

FIG. 9 illustrates another example method of communication implemented at a terminal device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “waking up”/“wakes up”/“wake up” or similar expression refers to an operation that enabling a transmission with a further device. In particular, an operation of waking up a SCG or PScell may refer to: all the serving cells of the SCG are activated, or the PScell of the SCG is activated. Additionally, an operation of waking up a SCG or PScell may refer to: all the serving cells of the SCG switching from dormant BWP to non-dormant BWP, or the PScell of the SCG switching from dormant BWP to non-dormant BWP. It should be appreciated that the concept of waking up is suitable for any device(s)/element(s)/module(s).

As used herein, the term “sleeping”/“sleeps”/“sleep” or similar expression refers to an operation that disenabling/suspending a transmission with a further device. In particular, an operation of sleeping a SCG or PScell may refer to: all the serving cells of the SCG are deactivated, or the PScell of the SCG are deactivated. Additionally, an operation of sleeping a SCG or PScell may also refer to: the SCG switching to dormant BWP, or the PScell of the SCG switching to dormant BWP It should be appreciated that the concept of sleeping is suitable for any device(s)/element(s)/module(s)

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a first device and a fourth device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IOT device or fixed IOT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As discussed above, in a DC scenario, a CA technology could be implemented for efficient frequency usage. However, introducing CA technology generally causes more power consumption of a terminal device (e.g., a UE).

One traditional solution of power saving for a CA scenario comprises activating/de activating SCell(s). To enable reasonable power consumption (for example, battery consumption) of the terminal device when CA is configured, an activation/deactivation mechanism of SCell(s) is supported. When a SCell is deactivated, the terminal device does not need to receive the corresponding PDCCH or PDSCH and cannot transmit in the corresponding uplink, while the terminal device is required to perform Channel Quality Indicator (CQI) measurements. Conversely, when a SCell is activated, the terminal device shall receive PDSCH and PDCCH (if the terminal device is configured to monitor PDCCH from said SCell), and the terminal device is expected to be able to perform CQI measurements.

Another traditional solution of power saving for a CA scenario comprises Scell Dormancy. To enable fast SCell activation when CA is configured, one dormant bandwidth part (BWP) can be configured for an SCell. If the active BWP of the activated SCell is a dormant BWP, the terminal device stops monitoring PDCCH on the SCell but continues performing channel state information (CSI) (such as, CQI) measurements, automatic gain control (AGC) and beam management, if configured. Downlink control information (DCI) is used to control entering/leaving the dormant BWP for one or more SCell(s) or one or more SCG(s). The dormant BWP is one of the UE's dedicated BWPs configured by network via dedicated radio resource control (RRC) signaling. The special Cell (SpCell) and PUCCH SCell cannot be configured with a dormant BWP.

Further, as discussed above, in a DC scenario, power consumption of the terminal device and the network is also a big issue, due to maintaining two radio links simultaneously. Taking the EN-DC as an example, in some cases, power consumption of the terminal device in NR network is 3 to 4 times higher than that of the terminal device in the LTE network. In order to reduce power consumption, it is proposed that SCG may be suspended/deactivated or may be configured in dormancy state in some cases. For example, in EN-DC deployment, the MN provides the basic coverage. When data rate requirement of the UE changes dynamically, e.g. from high to low, the SN may be deactivated or suspended to reduce power consumption.

It should be appreciated that the SCG deactivation mechanism is also needed for other MR-DC deployments, including but not limited to EN-DC, NGEN-DC, NR-DC. The terms “SCG suspension” and “SCG deactivation” are used interchangeably herein.

In addition. three options regarding modeling of the SCG suspension have been proposed as below:
Option 1, all serving cells associated with the SN including PScell and SCells are activated and the active BWP is configured as a dormant BWP.
Option 2, all serving cells associated with the SN including PScell and SCells are deactivated.
Option 3, the SCells of the SCG should be deactivated, while the PScell of the SCG should be activated and the active BWP is configured as a dormant BWP.

As can be seen from the above, when SCG is suspended/deactivated, the SCG transmission for all SRBs and data radio bears (DRBs) shall be suspended. However, several DC operations relating to SCG configuring procedures (such as, PSCell addition/modification/change, SN addition/modification/change and so on), may need the terminal device to perform an interaction (such as, performing an access ransom (RA), transmitting a radio resource control (RRC) Reconfiguration Complete message and so on) between the terminal device and the network device. However, when the SCG is suspended/deactivated, how to process the above-mentioned interactions have not been discussed.

According to some example embodiments of the present disclosure, there is proposed a solution for configuring SCG in case that the SCG is suspended/deactivated. In this solution, the network devices (such as, a MN and a SN) may exchange activity state (such as, activation or deactivation) information. More specifically, a first network device (for example, a MN) may transmit a request for configuring a SCG associated with a second network device (for example, a SN), where the request comprises first information about a first activity state for the SCG. Then the second network device may respond the first network with its current activity state (i.e., its actual activity state). Alternatively, the second network device may generate a first message for configuring a SCG associated with the second network device, where the first message comprises a parameter about a second activity state of the SCG. Then the second network device may transmit the generated first message to the first network device. In this way, the first network device can obtain the current/actual activity state of the second network device.

According to some other example embodiments of the present disclosure, there is proposed another solution for configuring SCG in case that the SCG is suspended/deactivated. In this solution, when a terminal device determines a condition for performing a configuration for a PScell of a SCG of a second network device is met and the SCG of the second network device is deactivated, the terminal device transmits a third message to the second network device of the SCG, where the third message indicates that the configuration for the PScell has been completed by the terminal device. Alternatively when the terminal device receives a fourth message for configuring a SCG of the second network from the second network device, where the fourth message comprising a second indication indicating the SCG is deactivated, the terminal device may transmit a fifth message to the second network device of the SCG, where the fifth message indicates that the configuration for the PScell has been completed by the terminal device. In this way, even the SCG is deactivated, the configuring for the SCG can be performed.

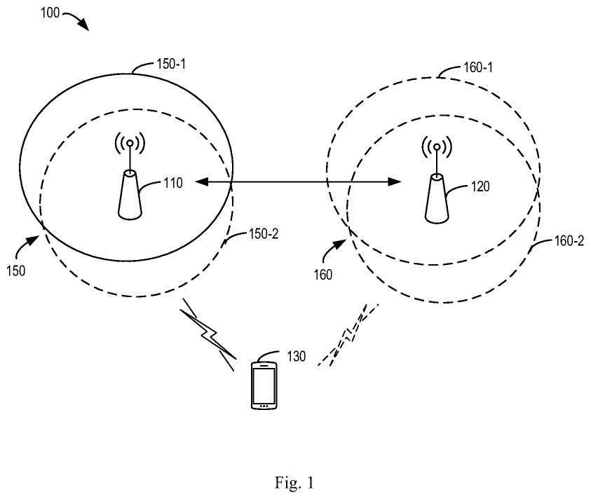

More details are described below with respect to FIGS. 1 to 10.

### Example Environment

FIG. 1 shows an example communication environment 100 in which example embodiments of the present disclosure can be implemented. In the communication environment 100, a terminal device 130 can communicate with a first network device 110 and additionally communicate with a second network device 120. The first network device 110 can communicate with the second network device 120 (such as, via X2 or Xn interface).

In the example of FIG. 1, the first network device 110 serves the terminal device 130 as the MN, while the second network device 120 serves the terminal device 130 as the SN. The serving areas of the first network devices 110 and the second network device 120 are called as cells. As shown in FIG. 1, a group of cells of the first network device 110 includes a primary cell 150-1 and an additional secondary cell (SCell) 150-2. Since the first network device 110 serves as the MN, the group of cells of the first network device 110 is referred to as MCG 150. A group of cells of the second network device 120 includes a primary cell 160-1 and an additional secondary cell 160-2. Since the second network device 120 serves as the SN, the group of cells of the second network device 120 is referred to as SCG 160 and the primary cell 160-1 is also referred to as PSCell 160-1.

Communications between the terminal device 130 and the network first device 110 and the terminal device 130 and the network second device 120 may be implemented according to any proper communication protocol(s). Communication in a direction from a terminal device 130 towards the first network device 110 or the second network device 120 is referred to as UL communication, while communication in a reverse direction from the first network device 110 or the second network device 120 towards the terminal device 130 is referred to as DL communication. The terminal device 130 can move amongst the coverage areas of the first network devices 110, the second network device 120 and possibly other network devices.

In UL communication, the terminal device 130 may transmit UL data and control information via a UL channel. In some examples embodiments, the UL data may be transmitted in a physical uplink shared channel (PUSCH) and/or any other UL channels that are available used for data transmission. In DL transmission, the first network device 110 or the second network device 120 may transmit DL data and control information to the terminal device 130 via a DL channel. In some examples, the DL data may be transmitted in a physical downlink shared channel (PDSCH) and/or any other DL channels that are available used for data transmission.

The DC provided by the first network device 110 and the second network 120 may comprise any suitable type of Multi-Radio Dual Connectivity (MR-DC), including but not limited to E-UTRA (Evolved Universal Terrestrial Radio Access)-NR Dual Connectivity (EN-DC), NGEN-DC, NE-DC and NR-DC. In the case of EN-DC, the first network device 110 is an eNB and the second network device 120 is a gNB. In the case of NGEN-DC, the first network device 110 is a gNB and the second network device 120 is an eNB. In the case of NR-DC, the network devices 110 and 120 are both gNBs.

It should be appreciated that the number of SCells in FIG. 1 is given for the purpose of illustration without suggesting any limitations to the present disclosure. In some other embodiments, the network first devices 110 and the second network 120 may provide any suitable number of SCells for serving the terminal device 130.

It should be appreciated that the number and type of devices in FIG. 1 are given for the purpose of illustration without suggesting any limitations to the present disclosure. The communication environment 100 may include any suitable number of network devices and/or terminal devices adapted for implementing implementations of the present disclosure. Further, the communication environment 100 may include any other devices than the network devices and the terminal devices, such as a core network element, but they are omitted here so as to avoid obscuring the present invention.

### Example Processes of Exchanging Activity State Information

Inventors of the present disclosure notice that the deactivated status may be not acceptable for the SGC sometimes, for example, the SCG is overloaded, or the SCG does not support SCG activation configuration and so on. Therefore, The MN needs to aware the actual/current activity state of the SCG, such that the MN may perform reasonable subsequent processing based on the actual/current activity state of the SCG. Some example embodiments of the present disclosure will be described in detail below.

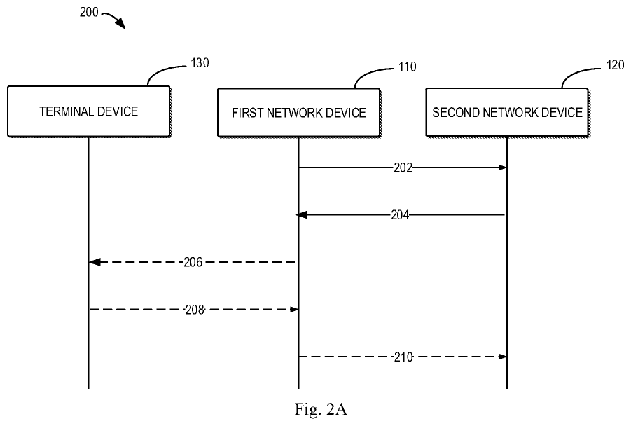

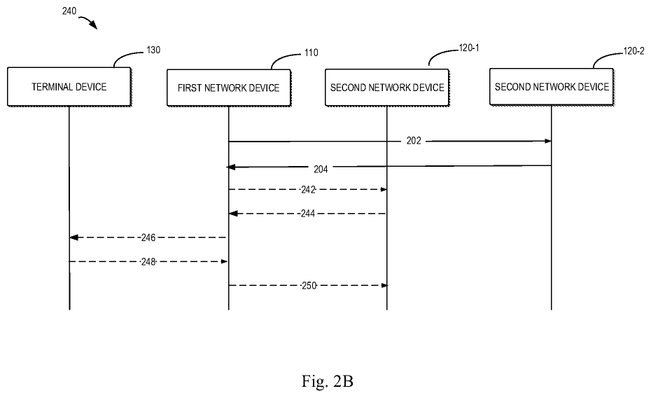

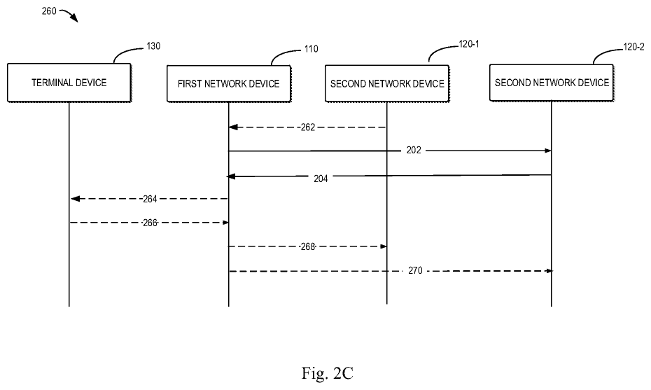

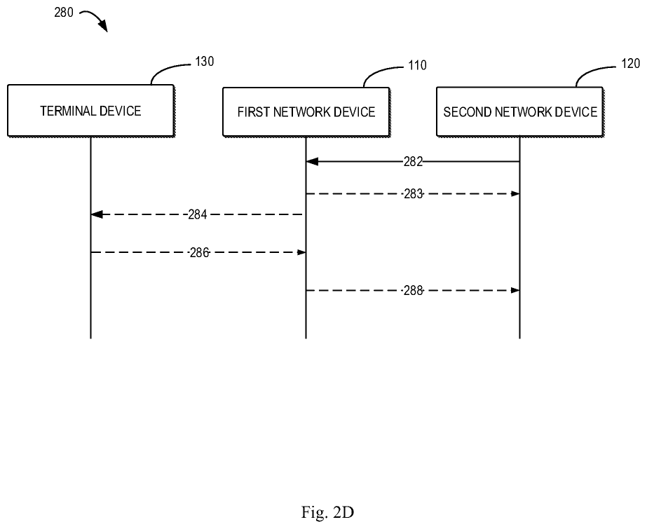

FIG. 2A is signaling chart illustrating process 200 of exchanging activity state information according to some embodiments of the present disclosure. For the purpose of discussion, the process 200 will be described with reference to FIG. 1. The process 200 may involve the terminal device 130, the first network device 110 and the second network device 120. In the process 200 of FIG. 2A, it is the first network device 110 acting as the MN to initiate the configuration procedure for SCG.

The first network device 110 transmits 202 a request for configuring a SCG associated with the second network device 120. The request may comprise first information about a first activity state for the SCG. The request may be transmitted via X2 or Xn interface.

In some example embodiments, the first network device 110 transmits a SN addition request comprising the first information in accordance with a determination that the SCG is to be added. For example, the first network device 110 transmits a SN addition request with SCG activation/deactivation request indication to the second network device 120.

Alternatively, in some example embodiments, the first network device 110 transmits a SN modification request comprising the first information in accordance with a determination that the SCG is to be modified. For example, the first network device 110 transmits a SN modification request with SCG activation/deactivation request indication to the second network device 120.

It should be appreciated that the above-mentioned messages are illustrated only for the purpose of illustration without suggesting any limitations. In other example embodiments, the request may be any suitable messages via X2 or Xn interface. It should also be appreciated that the first information about a first activity state for the SCG may be represented in any suitable manner, such as, indication, field, header and so on. Further, the first information about a first activity state for the SCG may be represented explicitly or implicitly. The scope of the present disclosure is not limited in these regards.

Upon receiving the request from the first network device 110, the second network device 120 may configure the SCG according to the request. Further, the second network device 120 may configure the activity state according to the first information comprised in the request. In some cases, such as, in case that the SCG of the second network device 120 is performing a transmission (including data or signalling) with the terminal device 130 or the SCG does not support SCG deactivation configuration and so on, the deactivation configuration for the SCG may be failed. In some other cases, in case that the second network device 120 is overloaded/busy (i.e., cannot provide further services), the activation configuration for the SCG may be failed. It should be understand that the above examples of failure configuration are merely given for the purpose of illustration without suggesting any limitations to the present disclosure.

Then, the second network device 120 determines a current activity state for the SCG. After that, the second network device 120 transmits 204 a response to the request to the first network device 110, where the response indicates the determined current activity state for the SCG.

In some example embodiments, the second network device 120 transmits a SN addition request acknowledgement as a response to a SN addition request. For example, the second network device 120 transmits a SN addition request Acknowledge with SCG activation/deactivation indication to the first network device 110.

Alternatively, in some example embodiments, the second network device 120 transmits a SN modification request acknowledgement as a response to a SN modification request. For example, the first network device 110 transmits a SN modification request Acknowledge with SCG activation/deactivation indication to the first network device 110.

It should be appreciated that the above-mentioned messages are illustrated only for the purpose of illustration without suggesting any limitations. In other example embodiments, the request may be any suitable messages via X2 or Xn interface. It should be appreciated that the second network device may indicate the determined current activity state explicitly or implicitly. Further, the current activity state also could be represented in any suitable manner, such as, indication, field, header and so on. The scope of the present disclosure is not limited in these regards.

In this way, during the SN/SCG addition/modification/change procedure, the first network device 110 (i.e., MN) can request the SN to activation/deactivated SCG and the SCG can response the MN with the actual/current state (activation/deactivation) of the SCG. Further, the actual/current state (activation/deactivation) of the SCG can be provided by the second network device 120 (i.e., SN). Based on the actual/current state (activation/deactivation) of the SCG, the first network device 110 may perform reasonable subsequent processing based on the actual activity state of the SCG. For example, the first network device 110 makes decision on whether to configure the SCG to the terminal device 130, or change to other SN.

Still referring to FIG. 2A, the first network device 110 transmits 206 a RRC message to the terminal device. The RRC message may comprise configuration information on the MCG of the first network device 110 and may also comprise configuration information on the SCG of the second networks device 120 (for example, an indication that indicates the SCG of the second networks device 120 is deactivated). Accordingly, the terminal device 130 may transmits 208 a RRC response to the first network device 110. The RRC response indicates that the configuration for the MCG has been complete, and further indicates the configuration for the SCG of second networks device 120 has been complete. Then, the first network device 110 may transmit 210 a message to the second network device 120 to complete the configuration of the SCG.

For purpose of illustration without any limitation to the scope of the present disclosure, the first network device 110 may transmit a RRCReconfiguration message to the terminal device 130. The terminal device 130 responds a RRCReconfigurationComplete carrying SN RRCReconfiguretionComplete message. Then the first network device 110 transmits a SN ReconfigurationComplete carrying SN RRCReconfiguretionComplete message to the second network device 120.

It should be appreciated that the activity state also could be exchanged during a SN change procedure between a source SN and a target SN. These procedures will be discussed by referring to FIGS. 2B and 2C. FIG. 2B is signaling chart illustrating process 240 exchanging activity state information during a SN change procedure between a source SN and a target SN initiated by the first network device 110 (i.e., MN). FIG. 2C is signaling chart illustrating process 260 exchanging activity state information during a SN change procedure between a source SN and a target SN initiated by the second network device 120 (i.e., SN). For the purpose of discussion, the processes 240 and 260 will be described with reference to FIG. 1. The processes 240 and 260 relate to the terminal device 130, the first network device 110, the second network devices 120-1 and 120-2. In the process 240 of FIG. 2B and the process 260 of FIG. 2C, the first network device 110 acts as the MN, the second network device 120-1 acts as the source SN and the second network device 120-2 acts as the target SN.

First referring to FIG. 2B, the first network device 110 (i.e., MN).transmits 202 a request for configuring a SCG associated with the second network device 120-2 (i.e., target SN). The request may comprise first information about a first activity state for the SCG of the second network device 120-2. As an example, the first network device 110 transmits a SN addition request with SCG activation/deactivation request indication.

Next, the second network device 120-2 may configure the SCG according to the request received at 202. Then the second network device 120-2 determines a current activity state for the SCG. The second network device 120-2 transmits 204 a response to the first network device 110, where the response indicates the determined current activity state for the SCG. As an example, the second network device 120-2 transmits a SN addition request Acknowledge with SCG activation/deactivation indication to the first network device 110.

Upon receiving the response from the second network device 120-2, the first network device 110 releases the connection with the second network device 120-1 (i.e., source SN). More specifically, the first network device 110 transmits 242 a SN Release request to the second network device 120-1 and receives 244 a SN Release request Acknowledge from the second network device 120-1.

Then, the first network device 110 triggers the terminal device 130 to complete the corresponding configuration. More specifically, the first network device 110 transmits 246 a RRCReconfiguration message to the terminal device 130 and receives 248 a RRCReconfigurationComplete carrying SN RRCReconfiguretionComplete message from the terminal device 130. The first network device 110 transmits 250 a SN ReconfigurationComplete carrying SN RRCReconfiguretionComplete message to the second network device 120-1.

In this way, the exchanging of activity state is implemented during the SN change procedure between a source SN and a target SN.

Now reference is made to FIG. 2C, where the SN change procedure between a source SN and a target SN is initiated by a SN. The second network device 120-1 determines to initiate a SN change procedure and transmits 262 a SN change request to the first network device 110. Upon receiving the SN change request, the first network device 110 transmits 202 a request for configuring a SCG associated with the second network device 120-2. The request may comprise first information about a first activity state for the SCG. As an example, the first network device 110 transmits a SN addition request with SCG activation/deactivation request indication.

Next, the second network device 120-2 may configure the SCG according to the request received at 202. Then, the second network device 120-2 determines a current activity state for the SCG. The second network device 120-2 transmits 204 a response to the first network device 110, where the response indicates the determined current activity state for the SCG. As an example, the second network device 120-2 transmits a SN addition request Acknowledge with SCG activation/deactivation indication to the first network device 110.

Upon receiving the response from the second network device 120-2, the first network device 110 triggers the terminal device 130 to complete the corresponding configuration. More specifically, the first network device 110 transmits 264 a RRCReconfiguration message to the terminal device 130 and receives 266 a RRCReconfigurationComplete carrying SN RRCReconfiguretionComplete message from the terminal device 130.

Next, the first network device 110 transmits 268 SN Change Confirmation to the second network device 120-1 and transmits 270 SN Reconfiguration complete message carrying SN RRC Reconfiguration complete message to the second network device 120-2, respectively.

In this way, the exchanging of activity state is implemented during the SN change procedure between a source SN and a target SN.

By referring to FIGS. 2B and 2C, the specific processes for exchanging the activity state during a SN change procedure between a source SN and a target SN have been discussed. It should be appreciated that the type and the sequence of the above-mentioned messages when discussing the processes of FIGS. 2B and 2C are illustrated only for the purpose of illustration without suggesting any limitations. In other example embodiments, the message can be replaced by any suitable message and be performed in any suitable order.

FIG. 2D is signaling chart illustrating process 280 of exchanging activity state information according to some embodiments of the present disclosure. For the purpose of discussion, the process 280 will be described with reference to FIG. 1. The process 280 may involve the terminal device 130, the first network device 110 and the second network device 120. In the process 280 of FIG. 2D, it is the second network device 120 acting as the SN to initiate the configuration procedure for SCG.

The second network device 120 generates a first message for configures a SCG associated with the second network device 120, where the first message comprises a parameter about a second activity state of the SCG. Then, the second network device 120 transmits 282 the first message to the first network device 110. For purpose of illustration without any limitation to the scope of the present disclosure, the second network device 120 transmits a SN modification required with a SCG activation/deactivation indication.

In some example embodiments, after transmitting the first message, the second network device 120 stars a timer. If the second network device 120 does not receive any message that indicates the configuration required by the first message has been completely performed, the second networked 120 determines that the first message is rejected by the first network device 110 or the terminal device 130, or the configuration required by the second network device failed to be configured by the first network device 110 or the terminal device 130.

Next, the first network device 110 may determine whether the configuration of the first message is acceptable or not. If the first network device 110 determines to accept the configuration of the first message, the first network device 110 transmits 284 a RRC Reconfiguration to the terminal device 130 and receives 286 a RRC Reconfiguration complete carrying SN RRC Reconfiguration Complete from the terminal device 130. Then the first network device 110 transmits 288 a SN Modification Confirmation carrying SN RRC Reconfiguration complete to the second network device 120.

Else, if the first network device 110 rejects the configuration of the first message, the first network device 110 responds 283 a second message additionally carrying the rejection reason or the first network device 110 just ignores the first message without responding any message to the second network device 120.

Additionally, if the first network device 110 determine the configuration required by the second network device failed to be configured by the first network device 110 or the terminal device 130 (for example, the first network device 110 does not receive a message from the terminal device 130 that indicates the configuration has been completely performed, or the first network device 110 receives a message from the terminal device 130 that indicates the configuration is failed), the first network device 110 may respond 283 a second message to indicates the failure additionally carrying the failure reason or the first network device 110 just ignores the first message without responding any message to the second network device 120.

It should be appreciated that the type and the sequence of the above-mentioned messages when discussing the processes of FIG. 2D are illustrated only for the purpose of illustration without suggesting any limitations. In other example embodiments, the message can be replaced by any suitable message and be performed in any suitable order.

In this way, when the SN initiates a SCG configuration, the SN can require an activity state expected by the SN, and the MN may complete the SCG configuration as required by the SN.

### Example Processes of Configuring a PSCell for a Deactivated SCG

Generally, when the terminal device 130 needs to configure (such as, add or change) a PScell, the terminal device 130 needs to perform an interaction (such as, performing a RA procedure, transmitting a RRC Reconfiguration Complete message and so on) between the terminal device 130 and the network device of the target PScell. However, as discussed, when the SCG is suspended/deactivated, both SRBs and DRSs between the terminal device 130 and the SCG are suspended, and random access procedure are not allowed. Therefore, it is desirable to specify the process for configuring a Pscell for a deactivated SCG.

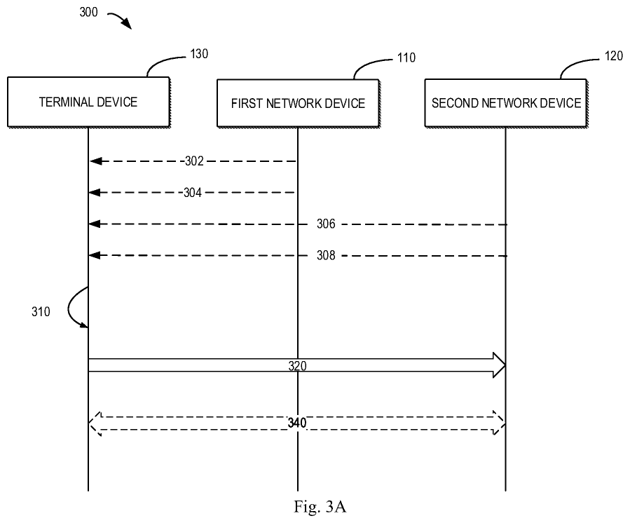

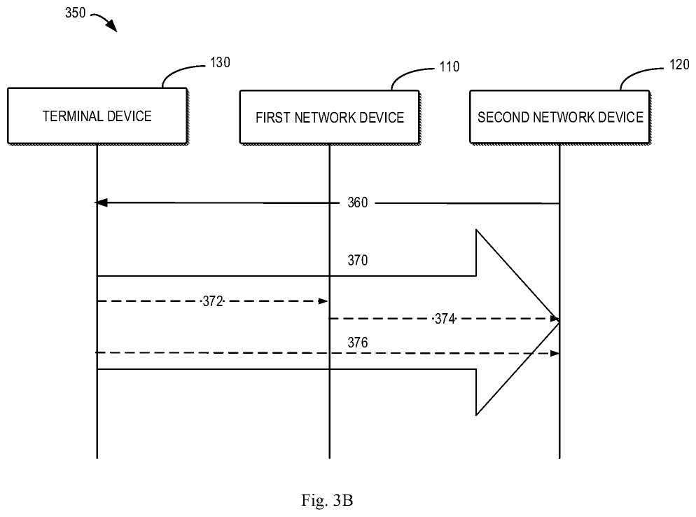

Examples for performing a configuration for a PScell of a SCG will be discussed by referring to FIG. 3A. FIG. 3A is signaling chart illustrating processes 300 for configuring SCG according to some embodiments of the present disclosure. For the purpose of discussion, the process 300 will be described with reference to FIG. 1. The process 300 may involve the terminal device 130, the first network device 110 and the second network device 120. For purpose of illustration without any limitation to the scope of the present disclosure, in the process 300 of FIG. 3A, the first network device 110 acts as MN and the second network device 120 acts as SN.

As shown in FIG. 3A, if the terminal device 130 determines that a condition for performing a configuration for a PScell of a SCG of a second network device 120 is met, the terminal device 130 determines 310 whether the SCG of the second network device 120 is deactivated.

Next, if the terminal device 130 determines that the SCG is deactivated, the terminal device 130 transmits 320 a third message to the second network device 120 of the SCG, where the third message indicates that the configuration for the PScell has been completed by the terminal device 130.

By this way, even the SCG is deactivated, the PScell of the SCG can be configured (such as, added or changed and so on).

Further, there are a plurality of scenarios in which the terminal device 130 needs to perform a configuration for a PScell. Accordingly, the present disclosure proposes a plurality of processes for different scenarios. In addition, the present disclosure also stipulates the process for RA procedure for the scenario that the SCG is deactivated.

Now, example processes according to the present discourse for different scenarios will be discussed as below. Further, it should be appreciated that the type and the sequence of the messages as will be illustrated below when discussing the processes of FIG. 3A are illustrated only for the purpose of illustration without suggesting any limitations. In other example embodiments, the message can be replaced by any suitable message and be performed in any suitable order.

The scenario that the MN initiates an addition/change of PScell for a deactivated SCG will be discussed first. Still referring to FIG. 3A, the terminal device 130 receives 302 a first RRC reconfiguration message for configuring the PScell of the SCG from the first network device 110 and then the terminal device 130 may determines the condition for performing a configuration for the PScell of the SCG is met. As an example, the terminal device 130 receives the RRCReconfiguration message of the SCG from the first network device 110 via SRB 1 and the RRCReconfiguration message comprises the reconfigurationWithSync element, the terminal device 130 determines to perform a PScell configuration (such as, addition or change of PScell).

Then the terminal device 130 determines 310 whether the SCG of the second network device 120 is deactivated. In some example embodiments, the determining is performed based on the original activity state of the SCG and the first RRC reconfiguration message revived at 302. In some example embodiments, the terminal device 130 determines that the SCG is deactivated if the first RRC reconfiguration message indicates the SCG is deactivated (such as, by an indication). Alternatively, in some other example embodiments, the terminal device 130 determines that the SCG is activated if the first RRC reconfiguration message indicates the SCG is activated (such as, by an indication). Further, in some other example embodiments, the terminal device 130 continually keep the original activity state if the first RRC reconfiguration message does not indicates an activity state of the SCG.

As an example, in case that a SCG is added and the RRCReconfiguration message (such as, SN addition message) indicates the SCG is deactivated (such as, by an indication), the terminal device 130 determines the SCG is deactivated. As another example, in case that the SCG is deactivated before the receiving the RRCReconfiguration message and the RRCReconfiguration message does not indicate the SCG is activated (such as, the RRCReconfiguration message indicates the SCG is deactivated or the RRCReconfiguration message does not include an indication that indicates an activity state of the SCG), the terminal device 130 determines the SCG is deactivated.

As discussed above, if the terminal device 130 determines that the SCG is deactivated, the terminal device 130 transmits 320 a third message to the second network device 120 of the SCG, where the third message indicates that the configuration for the PScell has been completed by the terminal device 130.

In some example embodiments, the terminal device 130 applies the configuration of the SCG and sends RRC Reconfiguration Complete message including an SN RRC response message for SN to the first network device 110 (i.e., MN), but the terminal device 130 does not initiate RA to the target PScell, so as to keep the SCG deactivated.

As an example for transmitting the third message, the terminal device 130 transmits the third message to the first network device 110, such that the third message is transmitted to the second network device 120 via the first network device 110. In addition, the terminal device 130 may suspend transmission with the second network device 120 to avoid a RA procedure for the PScell.

Alternatively, in some example embodiments, the terminal device 130 applies the configuration of the SCG but at least keep the PScell or SCG wake up. Then the terminal device 130 sends RRC Reconfiguration Complete message including an SN RRC response message for SN to the first network device 110 (i.e., MN). In addition, the terminal device 130 initiates RA to the target PScell and sleeps the PScell or the SCG after the completion of the RA procedure.

As another example for transmitting the third message, the terminal device 130 transmits the third message to the first network device 110, such that the third message is transmitted to the second network device 120 via the first network device 110. In addition, the terminal device 130 enables transmission with the second network device, performs a RA procedure for the PScell via the enabled transmission and suspends the transmission with the second network device in response to a completion of the RA procedure.

In this way, the handling of PSCell addition/change was specified in case of SCG deactivation.

Further, the SN also can initiate a configuring for Pscell. Also referring to FIG. 3A, the terminal device 130 receives 306 a second RRC reconfiguration message for configuring the PScell of the SCG from the second network device 120 and the second RRC reconfiguration message comprises an first indication indicating the SCG is deactivated. Then the terminal device 130 may determines the condition for performing a configuration for the PScell of the SCG is met, and further determines that the SCG is deactivated. As an example, the terminal device 130 receives the RRCReconfiguration message of the SCG from the second network device 120 via SRB 3, where the RRCReconfiguration message comprises the reconfigurationWithSync element and the RRCReconfiguration message indicates that the SCG is deactivated (such as, by a first indication). Then, the terminal device 130 determines to perform a PScell configuration (such as, change of PScell) and determines that the SCG is deactivated.

As an example, the SCG is activated before receiving the second RRC message, but a SCG deactivation indication is included in the second RRCReconfiguration message from the second network device 120 (i.e., SN) via SRB3. That is, the SCG deactivation is implemented during intra-SN modification. Then, the terminal device 130 determines the condition for performing a configuration for the PScell of the SCG is met and the SCG is deactivated.

As discussed above, if the terminal device 130 determines that the SCG is deactivated, the terminal device 130 transmits 320 a third message to the second network device 120 of the SCG, where the third message indicates that the configuration for the PScell has been completed by the terminal device 130.

In some example embodiments, in order to ensuring the SCG being deactivated, the terminal device 130 applies the configuration, sends ULInformationTransferMRDC message including an embedded RRCReconfigurationComplete message to the SN to the first network device. Further, the terminal device 130 does not initiate RA to the target Pscell.

As an example for transmitting the third message, the terminal device 130 transmits the third message to the first network device 110, such that the third message is transmitted to the second network device 120 via the first network device 110. In addition, the terminal device 130 may suspend transmission with the second network device 120 to avoid a RA procedure for the PScell.

In some example embodiments, the terminal device 130 may deactivate the SCG after sending a RRCReconfigurationComplete message to the second network device 120.

Alternatively, in some other example embodiments, the terminal device 130 applies the configuration of the SCG but at least keep the PScell or SCG wake up and SRB3 not suspended. Then, the terminal device 130 sends a RRC Reconfiguration Complete message to the second network device 120 (i.e., SN). In addition, the terminal device 130 initiates RA procedure o the target PSCell. Next, the terminal device sleeps the PScell or the SCG, and suspends SRB3.

As another example for transmitting the third message, the terminal device 130 enables transmission with the second network device 120, transmits the third message to the second network device 120 via the enabled transmission and suspends the enabled transmission with the second network device 120 in response to a completion of the transmission for the configuration complete message. In addition, the terminal device 130 performs a RA procedure for the PScell via the enabled transmission prior to suspending the enabled transmission.

In this way, the handling of PSCell addition/change was specified in case of SCG deactivation.

In addition, the terminal device 130 may receive a message for conditional PScell addition/change for a deactivated SCG from the first network device (i.e., MN). Before discussing the processes according to the present disclosure, a general conditional PScell change (CPC) or conditional PScell addition (CPA) mechanism without SRB 3 is described as below first.

In a scenario that the SCG is activated, the second network device 120 (i.e., SN) initiates the procedure by sending the SN Modification Required including the SN RRC reconfiguration message to the first network device 110. The first network device 110 forwards the SN RRC reconfiguration message including the RRC reconfiguration message to the terminal device 130. The terminal device 130 applies the new configuration and replies with the RRC reconfiguration complete message by including the SN RRC reconfiguration complete message. If CPC is configured in the RRCReconfiguration message, the terminal device 130 maintains connection with source PSCell after receiving CPC configuration, and starts evaluating the CPC execution conditions for the candidate PScell(s). If at least one CPC candidate PSCell satisfies the corresponding CPC execution condition, the terminal device 130 detaches from the source PScell, applies the stored corresponding configuration for the selected candidate PSCell and synchronizes to that candidate PScell. The terminal device 130 completes the CPC execution procedure by an ULInformationTransferMRDC message to the first network device 110 which includes an embedded RRCReconfigurationComplete message to the second network device 120. The first network device 110 forwards the SN RRC response message, if received from the terminal device 130, to the second network device 120 by including the SN RRC response message in the SN Modification Confirmation message. If being instructed, the terminal device 130 performs synchronization towards the PSCell of the second network device 120 as described in SN Addition procedure. Otherwise the terminal device 130 may perform UL transmission after having applied the new configuration.

Therefore, when receiving RRC Reconfiguration message for CPC or CPA configuration, the terminal device 130 sends a RRC Reconfiguration complete message to the MN. Further, when CPC execution condition is satisfied, the terminal device 130 shall sends RRC Reconfiguration Complete message to the MN and initiate RA procedure to the target Pscell, such that the network device can aware the information of the target pScell. However, if the SCG is deactivated, SRB3 and RA to the SN is not allowed generally. Additionally, if RA is not allowed, in case of multiple candidate PScells, the network device (such as, the first network device 110 and the second network device 120) is not aware of which candidate PScell is selected.

Inventors of the present discourse notice that if CPC or CPA configuration is received before SCG deactivation, although the SCG is deactivated later, the terminal device 130 may continue evaluating the CPC execution condition for the candidate PSCell(s). Further, Inventors of the present discourse also notice that if CPC configuration is received after SCG deactivation, the terminal device 130 may still evaluate the CPC execution conditions for candidate PSCell(s). Moreover, the information of the target Pscell (for example, identity of the target PScell) can be indicated in the RRC Reconfiguration Complete message. In this way, even the terminal device 130 does not initiate a RA procedure to the target Pscell, the network device (such as, the first network device 110 and the second network device 120) may aware the information of the target PScell. More details will be discussed as below.

Still referring to FIG. 3A, the terminal device 130 receives 304 a third RRC reconfiguration message for conditionally configuring the PScell of the SCG from the first network device 110. The third RRC reconfiguration message comprises second information of a plurality of candidate PScells. Then the terminal device 130 selects a target PScell to be switched from the plurality of candidate PScells according to the received third RRC reconfiguration message and determines the condition for performing a configuration for the PScell of the SCG is met.

It should be appreciated that the terminal device 130 may receive third RRC reconfiguration message for conditionally configuring the PScell in a plurality of scenarios, such as, conditional intra-SN PScell change without MN involvement when SRB3 is not used, conditional intra-SN PSCell change with MN involvement, conditional inter-SN PScell change, or conditional PSCell addition (CPC configuration is received by SRB1).

In addition, upon receiving the third RRC reconfiguration message, the terminal device 130 may apply the new configuration comprised in the third RRC message and reply with the RRC reconfiguration complete message by including the SN RRC reconfiguration complete message. In addition, the terminal device 130 stores the configuration for the plurality of candidate PScells. Next, the terminal device starts evaluating the CPC execution conditions for the candidate PScells and selects a target PScell to be switched from the plurality of candidate PScells. After selecting the target PScell, the terminal device 130 may determine that the condition for performing a configuration for the PScell of the SCG is met.

Then the terminal device 130 determines 310 whether the SCG of the second network device is deactivated. In some example embodiments, if the SCG is deactivated before the condition for performing a configuration for the PScell of the SCG is met/applying the stored configuration for the target PScell, and the stored configuration for the target PScell does not indicates that the SCG is activated (such as, by an indication), the terminal device 130 determines that the SCG is deactivated. In some other example embodiments, if the stored configuration for the target PScell indicates (such as, by an indication) that the SCG is deactivated, the terminal device 130 determines that the SCG is deactivated.

As an example, if the SCG is deactivated after the CPC configuration is received from the first network device 110 and the stored configuration does not indicate the SCG is activated, the terminal device 130 determines that the SCG is deactivated. As another example, if the SCG is activated before the CPC execution is triggered and the stored configuration indicates that the SCG is deactivated, the terminal device 130 determines that the SCG is deactivated.

As discussed above, if the terminal device 130 determines that the SCG is deactivated, the terminal device 130 transmits 320 a third message to the second network device 120 of the SCG, where the third message indicates that the configuration for the PScell has been completed by the terminal device 130.

In some example embodiments, the terminal device 130 applies the configuration of the SCG but does not initiate RA to the target Pscell. In some example embodiments, the terminal device 130 transmits a uplink message to first network device 110, where the uplink message indicates the information of the selected target PScell (such as, a target Pscell ID), such that the first network device can be aware of the selected target PSCell. In addition, the MN may transmit a further message to the second network device 120 to inform the information of the selected target PScell. In some embodiments, the information of the can be represented as an indication that indicates the identity of the target PScell.

In some example embodiments, the uplink message includes an embedded RRC ReconfigurationComplete message for SN and the information of the selected target PSCell. The embedded RRC ReconfigurationComplete message may be transmitted to the second network device 120. In some example embodiments, the embedded RRC ReconfigurationComplete message and the information of the selected target PSCell can be transmitted independently with each other. In some other example embodiments, the information of the selected target PSCell can be comprised in the embedded RRC ReconfigurationComplete message. Additionally, in some example embodiments, the uplink message is RRCReconfigurationComplete message, ULInformationTransferMRDC message, UE Assistance information message and the like.

As an example, the terminal device 130 transmits an ULInformationTransferMRDC message which includes an embedded RRCReconfigurationComplete message of the second network device 120 to the first network device 110. Wherein, the embedded RRCReconfigurationComplete message includes a target Pscell ID.

As an example for transmitting the third message, the terminal device 130 transmits the third message to the first network device 110, such that the third message is transmitted to the second network device by the first network device. In addition, the terminal device 130 suspends transmission with the second network device to avoid a RA procedure for the PScell.

Alternatively, in some other example embodiments, the terminal device 130 applies the configuration of the SCG but at least keep PScell or SCG wake up. Then, the terminal device 130 sends an ULInformationTransferMRDC message to the first network device 110. The ULInformationTransferMRDC message includes an embedded RRCReconfigurationComplete message to the second network device 120. Further, the first network device transmits a SgNB modification confirmation message to the second network device 120. In addition, the terminal device 130 initiates RAs to the target PScell, and sleeps the PScell or SCG after the successful completion of RA procedure.

As another example for transmitting the third message, the terminal device 130 transmits the third message to the first network device 110, such that the third message is transmitted to the second network device by the first network device. In addition, the terminal device 130 enables transmission with the second network device, performs a RA procedure for the target PScell via the enabled transmission and suspends the transmission with the second network device in response to a completion of the RA procedure.

In this way, the configuring of Pscell (such as, addition of change of PScell) can be performed during the CPC or CPA procedure when the SCG is deactivated.

The second network device (i.e., SN) may transmit a message for conditional PScell change for a deactivated SCG via SRB 3 to the terminal device 130. Before discussing the processes according to the present disclosure, a general CPC mechanism via SRB 3 is described first.

In a scenario that the SCG is activated, the second network device 120 (i.e., SN) sends the SN RRC reconfiguration message to the terminal device 130 through SRB3. The terminal device 130 applies the new configuration and replies the second network device 120 with SN RRC reconfiguration complete message. In case that the terminal device 130 is unable to comply with at least part of the configuration included in the SN RRC reconfiguration message, the terminal device 130 performs the reconfiguration failure procedure. If being instructed, the terminal device 130 performs synchronisation towards the PSCell of the second network device 130 in the manner that is similar with the manner in SN Addition procedure. Otherwise the terminal device 130 may perform UL transmission after having applied the new configuration. As for a CPC scenario, the terminal device 130 maintains connection with source PSCell after receiving CPC configuration, and starts evaluating the CPC execution conditions for the candidate PSCell(s). If at least one CPC candidate PSCell satisfies the corresponding CPC execution condition, the terminal device 130 detaches from the source PSCell, applies the stored corresponding configuration for that selected candidate PSCell and synchronizes to that candidate PSCell. The terminal device 130 completes the CPC execution procedure by sending an RRCReconfigurationComplete message to the second network device 120.

Therefore, when receiving RRC Reconfiguration message for CPC configuration, the terminal device 130 sends a RRC Reconfiguration complete message to the SN. Further, when CPC execution condition is satisfied, the terminal device 130 shall sends RRC Reconfiguration Complete message to the SN (directly or via MN), and initiate RA procedure to the target Pscell, such that the network device can aware the information of the target PScell. However, if the SCG is deactivated, SRB3 and RA to the SN is not allowed generally. Additionally, if RA is not allowed, in case of multiple candidate PScells, the network device (such as, the first network device 110 and the second network device 120) is not aware of which candidate PScell is selected.

Inventors of the present discourse notice that if CPC configuration is received before SCG deactivation, although the SCG is deactivated later, the terminal device 130 may continue evaluating the CPC execution condition for the candidate PSCell(s). Further, Inventors of the present discourse also notice that if CPC configuration is received after SCG deactivation, the terminal device 130 may still evaluate the CPC execution conditions for candidate PSCell(s). Moreover, the information of the target Pscell (for example, identity of the target PScell) can be indicated in the RRC Reconfiguration Complete message. In this way, even the terminal device 130 does not initiate a RA procedure to the target Pscell, the network device (such as, the first network device 110 and the second network device 120) may aware the information of the target PScell. More details will be discussed as below.

Still referring to FIG. 3A, the terminal device 130 receives 308 a third RRC reconfiguration message for conditionally configuring the PScell of the SCG from the second network device 120. The third RRC reconfiguration message comprises second information of a plurality of candidate PScells. Then the terminal device 130 selects a target PScell to be switched from the plurality of candidate PScells according to the received third RRC reconfiguration message and determines the condition for performing a configuration for the PScell of the SCG is met.

As an example, for a scenario of conditional intra SN PScell change without SN change with SRB3 configured, the terminal device 130 receives a third RRC reconfiguration message for conditionally configuring the PScell of the SCG from the second network device 120.

In addition, upon receiving the third RRC reconfiguration message, the terminal device 130 may applies the new configuration comprised in the third RRC message and replies the second network device 120 with SN RRC reconfiguration complete message. In addition, the terminal device 130 stores the configuration for the plurality of candidate PScells. Next, the terminal device starts evaluating the CPC execution conditions for the candidate PSCell(s) and selects a target PScell to be switched from the plurality of candidate PScells. After selecting the target PScell, the terminal device 130 may determine that the condition for performing a configuration for the PScell of the SCG is met.

Then the terminal device 130 determines 310 whether the SCG of the second network device is deactivated. In some example embodiments, if the SCG is deactivated before the condition for performing a configuration for the PScell of the SCG is met/applying the stored configuration for the target PScell, and the stored configuration for the target PScell does not indicates that the SCG is activated (such as, by an indication), the terminal device 130 determines that the SCG is deactivated. In some example embodiments, the stored configuration for the target PScell indicates (such as, by an indication) that the SCG is deactivated, the terminal device 130 determines that the SCG is deactivated.

As an example, in case that the SCG is deactivated after the CPC configuration is received from the first network device 110 and the stored configuration does not indicate the SCG is activated, the terminal device 130 determines that the SCG is deactivated. As another example, in case that the SCG is activated before the CPC execution is triggered, but the stored configuration indicates that the SCG is deactivated, the terminal device 130 determines that the SCG is deactivated.

As discussed above, if the terminal device 130 determines that the SCG is deactivated, the terminal device 130 transmits 320 a third message to the second network device 120 of the SCG, where the third message indicates that the configuration for the PScell has been completed by the terminal device 130.

In some example embodiments, the terminal device 130 applies the stored configuration, but does not initiates RA to the target Pscell. In some example embodiments, the terminal device 130 transmits a uplink message to first network device 110, where the uplink message indicates the information of the selected target PScell (such as, a target Pscell ID), such that the first network device can be aware of the selected target PSCell. In addition, the MN may transmit a further message to the second network device 120 to inform the information of the selected target PScell. In some embodiments, the information of the can be represented as an indication that indicates the identity of the target PScell.

In some example embodiments, the uplink message includes an embedded RRC ReconfigurationComplete message for SN and the information of the selected target PSCell. The embedded RRC ReconfigurationComplete message may be transmitted to the second network device 120. In some example embodiments, the embedded RRC ReconfigurationComplete message and the information of the selected target PSCell can be transmitted independently with each other. In some other example embodiments, the information of the selected target PSCell can be comprised in the embedded RRC ReconfigurationComplete message. Additionally, in some example embodiments, the uplink message is RRCReconfigurationComplete message, ULInformationTransferMRDC message, UE Assistance information message and the like.

As an example, the terminal device 130 transmits an ULInformationTransferMRDC message which includes an embedded RRCReconfigurationComplete message of the second network device 120 to the first network device 110. Wherein, the embedded RRCReconfigurationComplete message includes a target Pscell ID.

As an example for transmitting the third message, the terminal device 130 transmits the third message to the first network device 110, such that the third message is transmitted to the second network device by the first network device. In addition, the terminal device 130 suspends transmission with the second network device to avoid a random access (RA) procedure for the PScell.

Alternatively, in some example embodiments, the terminal device 130 applies the configuration of the SCG but at least keep PScell or SCG wake up. Then, the terminal device 130 activates SRB3 if needed, initiates RA to the target Pscell and sends RRCReconfiguationComplete to the second network device 120 via SRB3 if configured. Then, the terminal device 130 sleeps the PScell or SCG after successful transmission of RRC Reconfiguration Complete message and suspends SRB3.

As another example for transmitting the third message, the terminal device 130 enables transmission with the second network device, transmits the third message to the second network device via the enabled transmission and suspends the transmission with the second network device in response to a completion of the transmission for the configuration complete message. In addition, the terminal device 130 performs a RA procedure for the target PScell via the enabled transmission prior to suspending the transmission.

In this way, the configuring of Pscell (such as, change of PScell) can be performed during the CPC procedure when the SCG is deactivated.

### Example Process of Configuring SCG without Change of Pscell

FIG. 3B is signaling chart illustrating processes 350 for configuring SCG without change of PScell according to some embodiments of the present disclosure. For the purpose of discussion, the process 350 will be described with reference to FIG. 1. The process 350 may involve the terminal device 130, the first network device 110 and the second network device 120. For purpose of illustration without any limitation to the scope of the present disclosure, in the process 350 of FIG. 3B, the first network device 110 acts as MN and the second network device 120 acts as SN.

As shown in FIG. 3B, the terminal device 130 receives 360 a fourth message for configuring a SCG of the second network device. The fourth message comprises a second indication indicating the SCG is deactivated. Next, the terminal device 130 transmits 370 a fifth message to the second network device of the SCG. The fifth message indicates that the configuration for the PScell has been completed by the terminal device.

As an example for transmitting the third message, the terminal device 130 transmits the fifth message to a first network device, such that the fifth message is transmitted to the second network device via the first network device.

As another example for transmitting the third message, the terminal device 130 transmits enables transmission with the second network device, transmits the fifth message to the second network device via the enabled transmission and suspends the enabled transmission with the second network device in response to a completion of the transmission for the configuration complete message.

In this way, the terminal device 130 can configure a SCG even the SCG is deactivated.

### Example of Avoiding a SCG Configuration for a Deactivated SCG

In some example embodiments, in case that the SCG is deactivated, the first network device 110 or the second network device 130 ensures the configuration for a PScell of the SCG (such as, addition or change of PScell) cannot be performed. As an example, the first network device 110 or the second network device 120 does not transmits a RRC reconfiguration message with ReconfigurationWithSync of the PScell to the terminal device 130 if the SCG is deactivated.

In some example embodiments, element of ReconfigurationWithSync of the PScell and a SCG deactivation indication is configured to UE in separate RRC messages. More specifically, the procedure of SCG deactivation is performed after the procedure relating to the element of ReconfigurationWithSync.

In some example embodiments, if CPC configuration is received before SCG deactivation, the network device (such as, the first network device 110 or the second network device 120) configures the terminal device 130 to release the CPC configuration upon the SCG is deactivated. Alternatively, the terminal device 130 releases the CPC configuration if the SCG is deactivated.

In some example embodiments, after transmitting a RRC message for CPC or CPA, the first network device 110 determines that the SCG is deactivated. Then, the first network device 110 instructs the terminal device 130 to release the stored configuration for the candidate Pscell(s).

In some example embodiments, after transmitting a RRC message for CPC, the second network device 120 determines that the SCG is deactivated. Then, the second network device 120 instructs the terminal device 130 to release the stored configuration for the candidate Pscell(s).

In some example embodiments, after receiving a RRC message for CPC and CPA and before applying the stored configuration for a selected target PScell, the terminal device 130 determines that the SCG is deactivated. Then, the terminal device 130 releases the stored configuration for the candidate PScells.

In some example embodiments, the CPC/CPA configuration does not contain SCG deactivation indication.

In that way, by making restriction on the network configuration or specifying behavior of the terminal device (for example, deleting/releasing stored CPC configuration if the SCG is deactivated), the SCG configuring is avoided for a deactivated SCG.

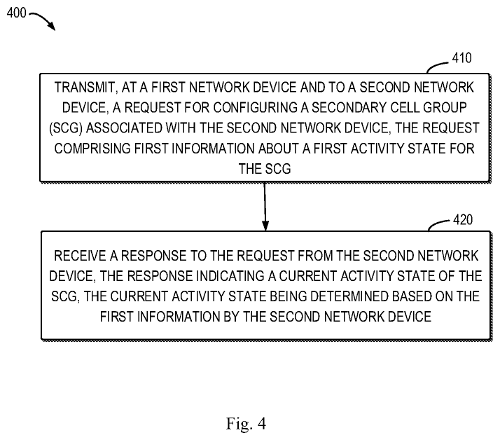

FIG. 4 illustrates a flowchart of an example method 400 according to some embodiments of the present disclosure. The method 400 can be implemented at the first network device 110 as shown in FIG. 1. It is to be understood that the method 400 may include additional blocks not shown and/or may omit some blocks as shown, and the scope of the present disclosure is not limited in this regard. For the purpose of discussion, the method 400 will be described from the perspective of the first network device 110 with reference to FIG. 1.

At block 410, the first network device 110 transmits a request for configuring a SCG associated with the second network device 120 to a second network device. The request comprises first information about a first activity state for the SCG. At block 410, the first network device 110 receives a response to the request from the second network device 120. The response indicates a current activity state of the SCG. The current activity state is determined based on the first information by the second network device 120

In some example embodiments, the first network device 110 transmits a SN addition request comprising the first information in accordance with a determination that the SCG is to be added. In some other embodiments, the first network device 110 transmits a SN modification request comprising the first information in accordance with a determination that the SCG is to be modified.

In some example embodiments, the first activity state for the SCG is activation or deactivation.

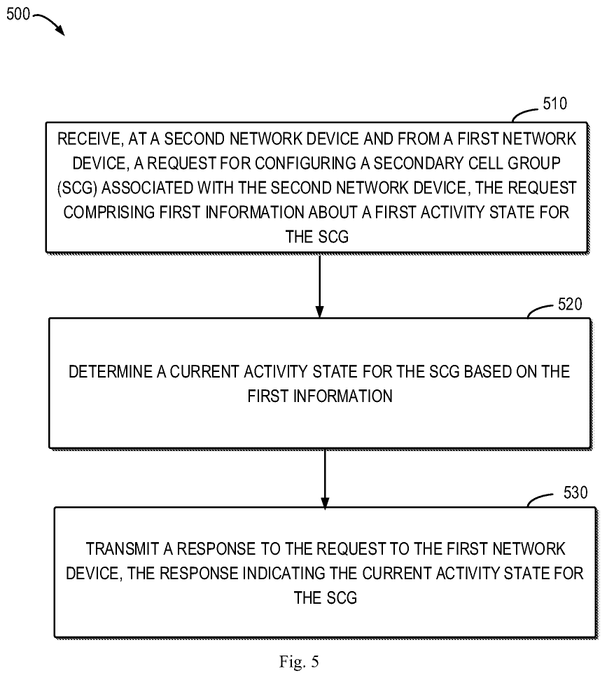

FIG. 5 illustrates a flowchart of an example method 500 according to some embodiments of the present disclosure. The method 500 can be implemented at the second network device 120 as shown in FIG. 1. It is to be understood that the method 500 may include additional blocks not shown and/or may omit some blocks as shown, and the scope of the present disclosure is not limited in this regard. For the purpose of discussion, the method 500 will be described from the perspective of the second network device 120 with reference to FIG. 1.

At block 510, the second network device 120 receives a request for configuring a SCG associated with the second network device 120 from a first network device 110. The request comprises first information about a first activity state for the SCG. At block 520, the second network device 120 determines a current activity state for the SCG based on the first information. At block 530, the second network device 120 transmits a response to the request to the first network device 110. The response indicates the current activity state for the SCG.

In some example embodiments, the second network device 120 receives a SN addition request in accordance with a determination that the SCG is to be added. In some other embodiments, the second network device 120 receives a SN modification request in accordance with a determination that the SCG is to be modified.

In some example embodiments, the first activity state for the SCG is activation or deactivation.

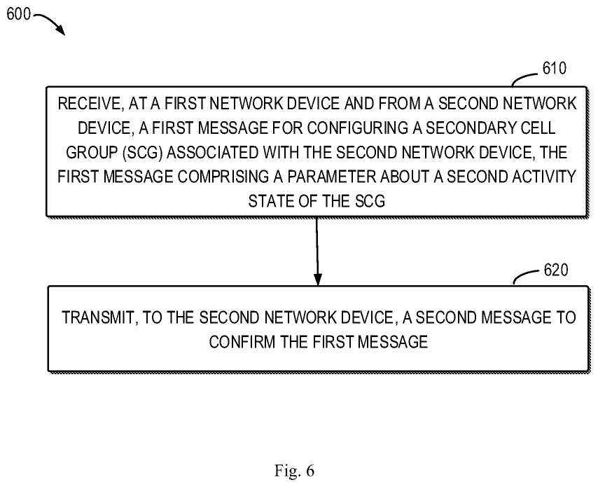

FIG. 6 illustrates a flowchart of an example method 600 according to some embodiments of the present disclosure. The method 600 can be implemented at the first network device 110 as shown in FIG. 1. It is to be understood that the method 600 may include additional blocks not shown and/or may omit some blocks as shown, and the scope of the present disclosure is not limited in this regard. For the purpose of discussion, the method 600 will be described from the perspective of the first network device 110 with reference to FIG. 1.

At block 610, the first network device 110 receives a first message for configuring a SCG associated with the second network device 120 from a second network device 120. The first message comprises a parameter about a second activity state of the SCG. At block 720, the network device 110 transmits a second message to the second network device 120 to confirm the first message.

instruct the terminal device 130 to perform a configuration for the SCG to a terminal device 130. The terminal device 130 is served by the first network device 110 and the second network device 120.

In some example embodiments, the second activity state for the SCG is activation or deactivation.

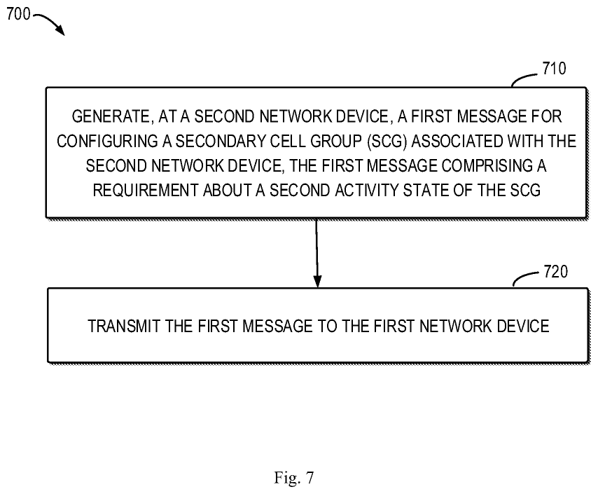

FIG. 7 illustrates a flowchart of an example method 700 according to some embodiments of the present disclosure. The method 700 can be implemented at the second network device 120 as shown in FIG. 1. It is to be understood that the method 700 may include additional blocks not shown and/or may omit some blocks as shown, and the scope of the present disclosure is not limited in this regard. For the purpose of discussion, the method 700 will be described from the perspective of the second network device 120 with reference to FIG. 1.

At block 710, the second network device 120 generates a first message for configuring a SCG associated with the second network device 120. The first message comprises a parameter about a second activity state of the SCG. At block 720, the second network device 120 transmits the first message to the first network device 110.

In some example embodiments, the second activity state for the SCG is activation or deactivation.

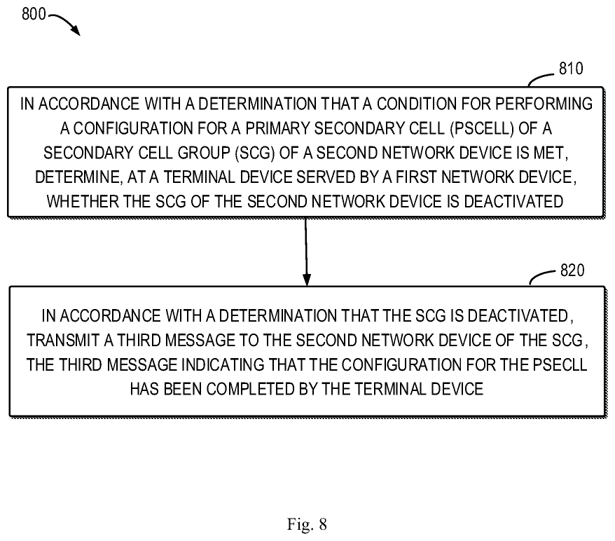

FIG. 8 illustrates a flowchart of an example method 800 according to some embodiments of the present disclosure. The method 800 can be implemented at the terminal device 130 as shown in FIG. 1. It is to be understood that the method 800 may include additional blocks not shown and/or may omit some blocks as shown, and the scope of the present disclosure is not limited in this regard. For the purpose of discussion, the method 800 will be described from the perspective of the terminal device 130 with reference to FIG. 1.

At block 810, the terminal device 130 determines whether the SCG of the second network device is deactivated in accordance with a determination that a condition for performing a configuration for a PScell of a SCG of a second network device 120. The terminal device 130 is served by a first network device 110. At block 820, the terminal device 130 transmits a third message to the second network device 120 of the SCG in accordance with a determination that the SCG is deactivated. The third message indicates that the configuration for the PScell has been completed by the terminal device 130.

In some example embodiments, the terminal device 130 receives a first RRC reconfiguration message for configuring the PScell of the SCG from the first network device 110. The terminal device 130 determines the condition for performing a configuration for the PScell of the SCG is met.

In some example embodiments, the terminal device 130 transmits the third message to the first network device 110, such that the third message is transmitted to the second network device 120 via the first network device 110. The terminal device 130 further suspends transmission with the second network device 120 to avoid a RA procedure for the PScell.

In some example embodiments, the terminal device 130 transmits the third message to the first network device 110, such that the third message is transmitted to the second network device 120 via the first network device 110. The terminal device 130 further enables transmission with the second network device 120, performs a RA procedure for the PScell via the enabled transmission and suspends the transmission with the second network device 120 in response to a completion of the RA procedure.

In some example embodiments, the terminal device 130 receives a second RRC reconfiguration message for configuring the PScell of the SCG from the second network device 120. The second RRC reconfiguration message comprises a first indication indicates the SCG is deactivated. The terminal device 130 determines the condition for performing a configuration for the PScell of the SCG is met.

In some example embodiments, the terminal device 130 transmits the third message to the first network device 110, such that the third message is transmitted to the second network device 120 via the first network device 110. The terminal device 130 further suspends transmission with the second network device 120 to avoid a RA procedure for the PScell.

In some example embodiments, the terminal device 130 enables transmission with the second network device 120, transmits the third message to the second network device 120 via the enabled transmission and suspends the enabled transmission with the second network device 120 in response to a completion of the transmission for the configuration complete message. The terminal device 130 further performs a RA procedure for the PScell via the enabled transmission prior to suspending the enabled transmission.

In some example embodiments, the terminal device 130 receives a third RRC reconfiguration message for conditionally configuring the PScell of the SCG from the first network device 110 or the second network device 120. The third RRC reconfiguration message comprises second information of a plurality of candidate PScells. The terminal device 130 selects a target PScell to be switched from the plurality of candidate PScells according to the received third RRC reconfiguration message and determines the condition for performing a configuration for the PScell of the SCG is met.

In some example embodiments, the terminal device 130 transmits the third message to the first network device 110, such that the third message is transmitted to the second network device 120 via the first network device 110 in response to the third RRC reconfiguration message is received from the first network device 110. The third message indicates the target PScell. The terminal device 130 further suspends transmission with the second network device 120 to avoid a RA procedure for the PScell.

In some example embodiments, the terminal device 130 transmits the third message to the first network device 110, such that the third message is transmitted to the second network device 120 by the first network device 110 in response the third RRC reconfiguration message is received from the first network device 110. The terminal device 130 further enables transmission with the second network device 120, performs a RA procedure for the target PScell via the enabled transmission and suspends the transmission with the second network device 120 in response to a completion of the RA procedure.

In some example embodiments, the terminal device 130 transmits the third message to the first network device 110 in response the third RRC reconfiguration message is received from the second network device 120, such that the third message is transmitted to the second network device 120 by the first network device 110, the third message indicating the target PScell. The terminal device 130 suspends transmission with the second network device 120 according to the received third RRC reconfiguration message to avoid a RA procedure for the PScell.

In some example embodiments, the terminal device 130 in response the third RRC reconfiguration message is received from the second network device 120, enables transmission with the second network device 120, transmits the third message to the second network device 120 via the enabled transmission and suspends the transmission with the second network device 120 in response to a completion of the transmission for the configuration complete message. The terminal device 130 further performs a RA procedure for the target PScell via the enabled transmission prior to suspending the transmission.

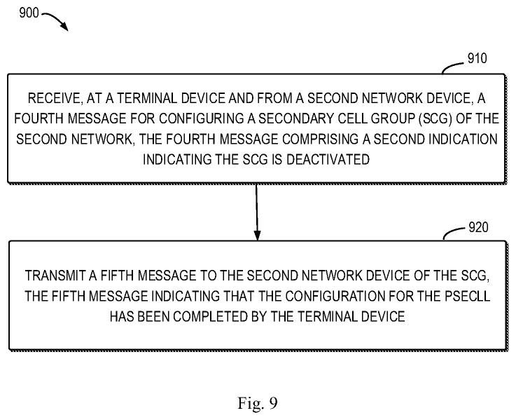

FIG. 9 illustrates a flowchart of an example method 900 according to some embodiments of the present disclosure. The method 900 can be implemented at the terminal device 130 as shown in FIG. 1. It is to be understood that the method 900 may include additional blocks not shown and/or may omit some blocks as shown, and the scope of the present disclosure is not limited in this regard. For the purpose of discussion, the method 900 will be described from the perspective of the terminal device 130 with reference to FIG. 1.

At block 910, the terminal device 130 receives a fourth message for configuring a SCG of the second network from a second network device 120. The fourth message comprises a second indication indicating the SCG is deactivated. At block 920, the terminal device 130 transmits a fifth message to the second network device 120 of the SCG. The fifth message indicates that the configuration for the PScell has been completed by the terminal device 130.

In some example embodiments, the terminal device 130 transmits the fifth message to a first network device 110, such that the fifth message is transmitted to the second network device 120 via the first network device 110.

In some example embodiments, the terminal device 130 enables transmission with the second network device 120, transmits the fifth message to the second network device 120 via the enabled transmission and suspends the enabled transmission with the second network device 120 in response to a completion of the transmission for the configuration complete message.

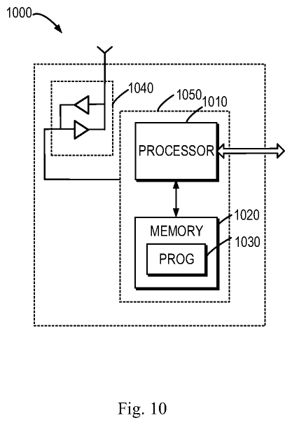

FIG. 10 is a simplified block diagram of a device 1000 that is suitable for implementing embodiments of the present disclosure. The device 1000 can be considered as a further example implementation of the terminal device 130, the second network device 120, or the first network device 110 as shown in FIG. 1. Accordingly, the device 1000 can be implemented at or as at least a part of the terminal device 130, the second network device 120, or the first network device 110.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device 130.

The program 1030 is assumed to include program instructions that, when executed by the associated processor 1010, enable the device 1000 to operate in accordance with the embodiments of the present disclosure, as discussed herein with reference to FIGS. 2A, 2B, 3, 6A, 6B, 7, 9 and 10. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1010 may form processing means 1050 adapted to implement various embodiments of the present disclosure.

The memory 1010 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1010 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2A-2D, 3A, 3B, 4 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
transmitting, at a first network device and to a second network device, a request for configuring a secondary cell group (SCG) associated with the second network device, the request comprising first information about a first activity state for the SCG; and
receiving a response to the request from the second network device, the response indicating a current activity state of the SCG, the current activity state being determined based on the first information by the second network device.

2. The method of claim 1, wherein transmitting the request comprises:
in accordance with a determination that the SCG is to be added, transmitting a secondary node (SN) addition request comprising the first information; and
in accordance with a determination that the SCG is to be modified, transmitting a SN modification request comprising the first information.

3. The method of claim 1, wherein the first activity state for the SCG is activation or deactivation.

4. A method of communication comprising:
receiving, at a second network device and from a first network device, a request for configuring a secondary cell group (SCG) associated with the second network device, the request comprising first information about a first activity state for the SCG; and
determining, a current activity state for the SCG based on the first information; and
transmitting a response to the request to the first network device, the response indicating the current activity state for the SCG.

5. The method of claim 4, wherein receiving the request comprises:
in accordance with a determination that the SCG is to be added, receiving a secondary node (SN) addition request; and
in accordance with a determination that the SCG is to be modified, receiving a SN modification request.

6. The method of claim 4, wherein the first activity state for the SCG is activation or deactivation.

7. A method of communication comprising:
receiving, at a first network device and from a second network device, a first message for configuring a secondary cell group (SCG) associated with the second network device, the first message comprising a parameter of a second activity state of the SCG; and
transmitting, to the second network device, a second message to confirm the first message.

8. The method of claim 7, wherein the second activity state for the SCG is activation or deactivation.

9. A method of communication comprising:
generating, at a second network device, a first message for configuring a secondary cell group (SCG) associated with the second network device, the first message comprising a parameter about a second activity state of the SCG; and
transmitting the first message to the first network device.

10. The method of claim 9, wherein the second activity state for the SCG is activation or deactivation.

11. A method of communication comprising:
in accordance with a determination that a condition for performing a configuration for a primary secondary cell (PScell) of a secondary cell group (SCG) of a second network device is met, determining, at a terminal device served by a first network device, whether the SCG of the second network device is deactivated; and
in accordance with a determination that the SCG is deactivated, transmitting a third message to the second network device of the SCG, the third message indicating that the configuration for the PScell has been completed by the terminal device.

12. The method of claim 11, further comprising:
receiving, from the first network device a first radio resource control (RRC) reconfiguration message for configuring the PScell of the SCG; and
determining the condition for performing a configuration for the PScell of the SCG is met.

13. The method of claim 12,
wherein transmitting the third message comprises:
transmitting the third message to the first network device, such that the third message is transmitted to the second network device via the first network device; and
wherein the method further comprises:
suspending transmission with the second network device to avoid a random access (RA) procedure for the PScell.

14. The method of claim 12,
wherein transmitting the third message comprises:
transmitting the third message to the first network device, such that the third message is transmitted to the second network device via the first network device; and
wherein the method further comprises:
enabling transmission with the second network device;
performing a random access (RA) procedure for the PScell via the enabled transmission; and
suspending the transmission with the second network device in response to a completion of the RA procedure.

15. The method of claim 11, further comprising:
receiving, from the second network device, a second radio resource control (RRC) reconfiguration message for configuring the PScell of the SCG, the second RRC reconfiguration message comprising an first indication indicating the SCG is deactivated; and
determining the condition for performing a configuration for the PScell of the SCG is met.

16. The method of claim 15,
wherein transmitting the third message comprises:
transmitting the third message to the first network device, such that the third message is transmitted to the second network device via the first network device; and
wherein the method further comprises:
suspending transmission with the second network device to avoid a random access (RA) procedure for the PScell.

17. The method of claim 15,
wherein transmitting the third message comprises:
enabling transmission with the second network device;
transmitting the third message to the second network device via the enabled transmission;
suspending the enabled transmission with the second network device in response to a completion of the transmission for the configuration complete message; and
wherein the method further comprises:
performing a random access (RA) procedure for the PScell via the enabled transmission prior to suspending the enabled transmission.

18. The method of claim 11, further comprising:
receiving, from the first network device or the second network device, a third radio resource control (RRC) reconfiguration message for conditionally configuring the PScell of the SCG, the third RRC reconfiguration message comprising second information of a plurality of candidate PScells;
selecting a target PScell to be switched from the plurality of candidate PScells according to the received third RRC reconfiguration message; and
determining the condition for performing a configuration for the PScell of the SCG is met.

19. The method of claim 18,
wherein transmitting the third message comprises:
in response to the third RRC reconfiguration message is received from the first network device, transmitting the third message to the first network device, such that the third message is transmitted to the second network device via the first network device, the third message indicating the target PScell; and
wherein the method further comprise:
suspending transmission with the second network device to avoid a random access (RA) procedure for the PScell.

20. The method of claim 18,
wherein transmitting the third message comprises:
in response the third RRC reconfiguration message is received from the first network device, transmitting the third message to the first network device, such that the third message is transmitted to the second network device by the first network device; and
wherein the method further comprises:
enabling transmission with the second network device;
performing a random access (RA) procedure for the target PScell via the enabled transmission; and
suspending the transmission with the second network device in response to a completion of the RA procedure.

21. The method of claim 18,
wherein transmitting the third message comprises:
in response the third RRC reconfiguration message is received from the second network device, transmitting the third message to the first network device, such that the third message is transmitted to the second network device by the first network device, the third message indicating the target PScell; and
wherein the method further comprises:
suspending transmission with the second network device according to the received third RRC reconfiguration message to avoid a random access (RA) procedure for the PScell.

22. The method of claim 18,
wherein transmitting the third message comprises:
in response the third RRC reconfiguration message is received from the second network device,
enabling transmission with the second network device;
transmitting the third message to the second network device via the enabled transmission; and
suspending the transmission with the second network device in response to a completion of the transmission for the configuration complete message, and
wherein the method further comprises:
performing a random access (RA) procedure for the target PScell via the enabled transmission prior to suspending the transmission.

23. A method of communication comprising,
receiving, at a terminal device and from a second network device, a fourth message for configuring a secondary cell group (SCG) of the second network device, the fourth message comprising a second indication indicating the SCG is deactivated; and
transmitting a fifth message to the second network device of the SCG, the fifth message indicating that the configuration for the PScell has been completed by the terminal device.

24. The method of claim 23, wherein transmitting the fifth message comprises:
transmitting the fifth message to a first network device, such that the fifth message is transmitted to the second network device via the first network device.

25. The method of claim 23, wherein transmitting the fifth message comprises:
enabling transmission with the second network device;
transmitting the fifth message to the second network device via the enabled transmission; and
suspending the enabled transmission with the second network device in response to a completion of the transmission for the configuration complete message.

26. A network device comprising:
a processor; and
a memory coupled to the processor and storing instructions thereon, the instructions, when executed by the processor, causing the network device to perform the method according to any of claims 1 to 3.

27. A network device comprising:
a processor; and
a memory coupled to the processor and storing instructions thereon, the instructions, when executed by the processor, causing the network device to perform the method according to any of claims 4 to 6.

28. A network device comprising:
a processor; and
a memory coupled to the processor and storing instructions thereon, the instructions, when executed by the processor, causing the network device to perform the method according to claim 7 or 8.

29. A network device comprising:
a processor; and
a memory coupled to the processor and storing instructions thereon, the instructions, when executed by the processor, causing the network device to perform the method according to claim 9 or 10.

30. A terminal device comprising:
a processor; and
a memory coupled to the processor and storing instructions thereon, the instructions, when executed by the processor, causing the network device to perform the method according to any of claims 11 to 22.

31. A terminal device comprising:
a processor; and
a memory coupled to the processor and storing instructions thereon, the instructions, when executed by the processor, causing the network device to perform the method according to any of claims 23 to 25.

32. A computer readable medium having instructions stored thereon, the instructions, when executed on at least one processor, causing the at least one processor to perform the method according to any of claims 1 to 3.

33. A computer readable medium having instructions stored thereon, the instructions, when executed on at least one processor, causing the at least one processor to perform the method according to any of claims 4 to 6.

34. A computer readable medium having instructions stored thereon, the instructions, when executed on at least one processor, causing the at least one processor to perform the method according to claim 7 or 8.

35. A computer readable medium having instructions stored thereon, the instructions, when executed on at least one processor, causing the at least one processor to perform the method according to claim 9 or 10.

36. A computer readable medium having instructions stored thereon, the instructions, when executed on at least one processor, causing the at least one processor to perform the method according to any of claims 11 to 22.

37. A computer readable medium having instructions stored thereon, the instructions, when executed on at least one processor, causing the at least one processor to perform the method according to any of claims 23 to 25.
